(19) United States
(12) Patent Application Publication
(10) Pub. No.: US 2013/0226831 A1
(43) Pub. Date: Aug. 29, 2013

(54) COPPER INDEX METHODOLOGY

(71) Applicants: K. Geert ROUWENHORST, New Haven, CT (US); Adam Dunsby, Easton, CT (US); Kurt J. Nelson, Norwalk, CT (US); Ashraf R. Rizvi, New Canaan, CT (US)

(72) Inventors: K. Geert ROUWENHORST, New Haven, CT (US); Adam Dunsby, Easton, CT (US); Kurt J. Nelson, Norwalk, CT (US); Ashraf R. Rizvi, New Canaan, CT (US)

(73) Assignee: SUMMERHAVEN INDEX MANAGEMENT, LLC, Stamford, CT (US)

(21) Appl. No.: 13/665,235

(22) Filed: Oct. 31, 2012

Related U.S. Application Data
(60) Provisional application No. 61/628,416, filed on Oct. 31, 2011.

(51) Int. Cl. G06Q 40/06

(52) U.S. Cl. CPC G06Q 40/06
USPC 705/36 R

(57) ABSTRACT

A computer-generated copper index usable as an investment benchmark for copper as an asset is based on a determination of eligible copper futures contracts based on an evaluation of backwardation or Contango, SCI excess return, and SCI total return.

### CROSS-REFERENCE TO RELATED APPLICATION

This application derives from U.S. Provisional Application Ser. No. 61/628,416, filed Oct. 31, 2011, the contents of which are incorporated herein by reference and the priority of which is hereby claimed.

### BACKGROUND OF INVENTION

1. Field of the Invention

This invention relates to determination using a computer, of a dynamic copper index that is of value to investors in making decision regarding the advisability of investing in copper contracts.

2. Summary of the Invention

The SummerHaven Copper Index is a single-commodity index designed to be an investment benchmark for copper as an asset class. The Copper Index is composed of copper futures contracts on the COMEX exchange. The Copper Index attempts to maximize backwardation and minimize contango while utilizing contracts in liquid portions of the futures curve.

The Copper Index is rules-based and is rebalanced monthly based on observable price signals described below in the section Contract Selection and Weighting. In this context, the term “rules-based” is meant to indicate that the composition of the Copper Index in any given month will be determined by quantitative formulas relating to the prices of the futures contracts that are included in the Copper Index. Such formulas are not subject to adjustment based on other factors.

The overall return on the Copper Index is generated by two components: (i) uncollateralized returns from the Benchmark Component Copper Futures Contracts comprising the Copper Index, and (ii) a daily fixed income return reflecting the interest earned on a hypothetical 3-month U.S. Treasury Bill collateral portfolio, calculated using the weekly auction rate for the 3-Month U.S. Treasury Bills published by the U.S. Department of the Treasury.

Table 1 below lists the Futures Exchange on which the Eligible Copper Futures Contracts are listed and quotation details. Table 2 lists the Eligible Copper Futures Contracts, their sector designation and maximum allowable tenor.

TABLE 1

| | Designated | | | |
|---|---|---|---|---|
| Commodity | Contract | Exchange | Units | Quote |
| Copper | Copper | COMEX | 25,000 lbs. | U.S. cents/pound |

TABLE 2

| | Commodity | | Max. |
|---|---|---|---|
| Commodity Name | Symbol | Allowed Contracts | Tenor |
| Copper | HG | All 12 calendar months | 19 |

Prior to the end of each month, SummerHaven Indexing determines the composition of the Copper Index. Values of the Copper Index are computed and disseminated approximately every fifteen (15) seconds from 8:00 a.m. to 5:00 p.m., New York City time. A daily Copper Index value is published at approximately 5:30 p.m., New York City time, under the index ticker “SDAI TR.” Only settlement and last-sale prices are used in the Copper Index's calculation, bids and offers are not recognized—including limit-bid and limit-offer price quotes. Where no last last-sale price exists, typically in the more deferred contract months, the previous days' settlement price is used. This means that the underlying Copper Index may lag its theoretical value. This tendency to lag is evident at the end of the day when the Copper Index value is based on the settlement prices of the Benchmark Component Copper Futures Contracts, and explains why the underlying Copper Index often closes at or near the high or low for the day.

Composition of the Copper Index

The composition or the Copper Index on any given day, as determined and published by SummerHaven Indexing, is determinative of the benchmark for USCUI.

Contract Expiration

Because the Copper Index is comprised of actively traded contracts with scheduled expirations, it can be calculated only by reference to the prices of contracts for specified expiration, delivery or settlement periods, referred to as contract expirations. The contract expirations included in the Copper Index for each commodity during a given year are designated by SummerHaven Indexing, provided that each contract must be an active contract. An active contract for this purpose is a liquid, actively-traded contract expiration, as defined or identified by the relevant trading facility or, if no such definition or identification is provided by the relevant trading facility, as defined by standard custom and practice in the industry.

Contract Selection and Weighting

Weights for each of the Benchmark Component Copper Futures Contracts are determined for the next month. The methodology used to evaluate the Copper Index weighting is based solely on quantitative data using observable futures prices and is not subject to human bias.

The monthly weighting selection is a three-step process based upon examination of the relevant futures prices for copper:

1) On the Selection Date at the end of each month, the copper futures curve is assessed to be in either Backwardation or Contango. A futures curve in Backwardation occurs when the price of the nearest-to-maturity contract is greater than or equal to the price of the third nearest-to-maturity contract. These contracts will have expirations that are approximately two months apart. A curve not in Backwardation is defined as being in Contango, which occurs when the price of the nearest-to-maturity contract is less than the price of the third nearest-to-maturity contract.

2a) BACKWARDATION: If the copper futures curve is in Backwardation, the following occurs: The annualized percentage price difference between the closest-to-expiration Eligible Copper Futures Contract and the Eligible Copper Futures Contract calculated for each of the four nearest Eligible Copper Futures Contracts on the Selection Date. The Copper Index takes equal positions in each of the two Eligible Copper Futures Contracts with the highest annualized percentage price difference.

A hypothetical example is included below, with the two selected eligible copper futures contracts shaded below (the selected commodities are ranked 1 and 2):

| Copper Futures Contract | Expiration Date | Contract Price |
|---|---|---|
| Nearest-to-maturity | November - 10 | 374.70 |
| Third nearest-to-maturity | January - 11 | 365.20 |

| Eligible Copper | | Annualized Percentage | |
|---|---|---|---|
| Futures Contracts | Price | Price Difference | Ranking |
| January - 11 | 365.20 | 10.47% | 1 |
| February - 11 | 363.00 | 10.15% | 4 |
| March - 11 | 359.70 | 10.36% | 3 |
| April - 11 | 356.60 | 10.41% | 2 |

2b) CONTANGO: If the futures curve is in Contango, then 50% of the Copper Index position is placed in the Backwardation portfolio (described above) with the remaining 50% placed in the nearest-to-maturity December Eligible Copper Futures Contract that has expiration more distant than the fourth nearest Eligible Copper Futures Contract.

A hypothetical example is included below, with the next two selected Eligible Copper Futures Contracts shaded below (the selected commodities are ranked 1-2):

| Copper Futures Contract | Expiration Date | Contract Price |
|---|---|---|
| Nearest-to-maturity | November - 10 | 374.00 |
| Third nearest-to-maturity | January - 11 | 375.70 |

| Eligible Copper | | Annualized Percentage | |
|---|---|---|---|
| Futures Contracts | Price | Price Difference | Ranking |
| January - 11 | 375.70 | −1.97% | 4 |
| February - 11 | 376.00 | −1.78% | 3 |
| March - 11 | 376.30 | −1.59% | 2 |
| April - 11 | 376.40 | −1.37% | 1 |

Due to the dynamic monthly weighting calculation, the individual weights will vary over time, depending on the price observations each month. The Selection Date for the Copper Index is the last business day of the calendar month.

FIG. 1 shows the weights of the Benchmark Component Copper Futures Contracts selected for inclusion in the Copper Index as of November 2010.

Portfolio Construction

The portfolio rebalancing takes place during the Rebalancing Period. At the end of each of the days in the Rebalancing Period one fourth of the prior months portfolio positions are replaced by the new weights for the Benchmark Component Copper futures Contracts determined on the Selection Date.

Copper Index Return Calculation

The percentage excess return equals the percentage change of the market values of the underlying commodity futures. During the Rebalancing Period, the Copper Index changes its contract holdings and weightings during a four day period.

The value of the SCI Excess Return (“SCI ER”) at the end of ‘a business day “t” is equal to the SCI ER value on day “t-1” multiplied by the sum of the daily percentage price changes of each commodity future factoring in each respective commodity future's notional holding on day “t-1”.

Rebalancing Period

The Copper Index is rebalanced during the first 4 business days of each calendar month, when existing positions are placed by new positions and weightings based on the signals used for contract selection on the last business day of the prior calendar month as outlined above.

Total Return Calculation

The value of the SCI Total Return (“SCI TR”) on any business day is equal to the product of (i) the value of the SCI TR on the immediately preceding business day multiplied by (ii) one plus the sum of the day's SCI ER returns and one business day's interest from the hypothetical U.S. Treasury Bill portfolio.

Copper Index Base Level

The SCI TR was set to 100 on Jan. 2, 1991.

### BRIEF DESCRIPTION OF THE DRAWINGS

FIG. 1 shows the weights of the benchmark component copper futures contracts selected for inclusion in the Copper Index as of November 2010,

FIGS. 2a-2c, 3a-3c, 4a-4n represent example calculations of the inventive copper index.

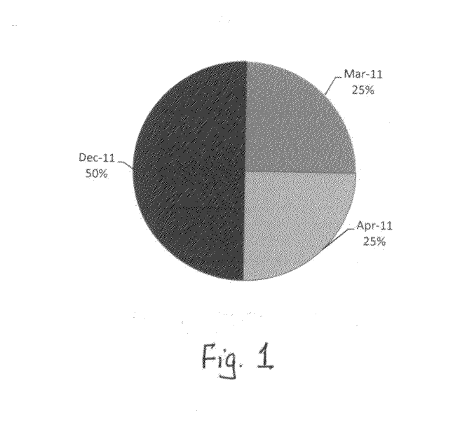

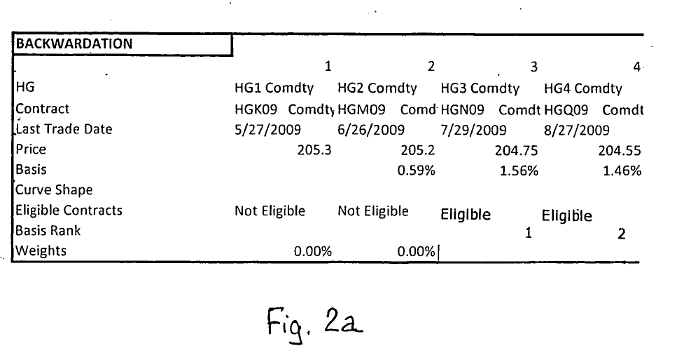

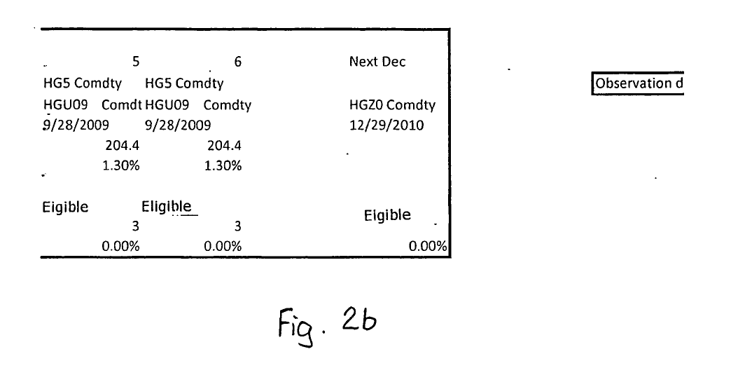

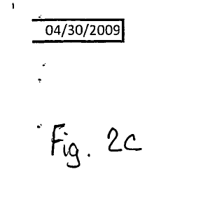

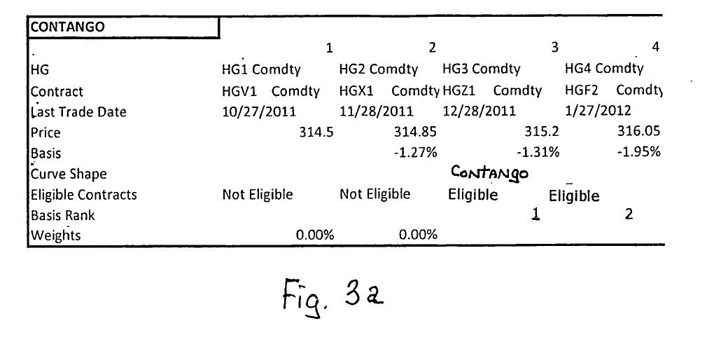

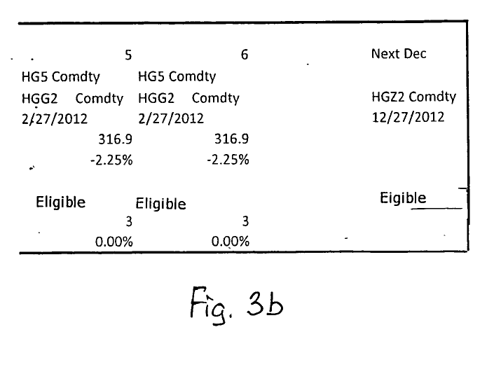

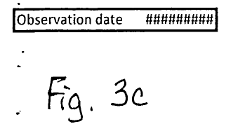

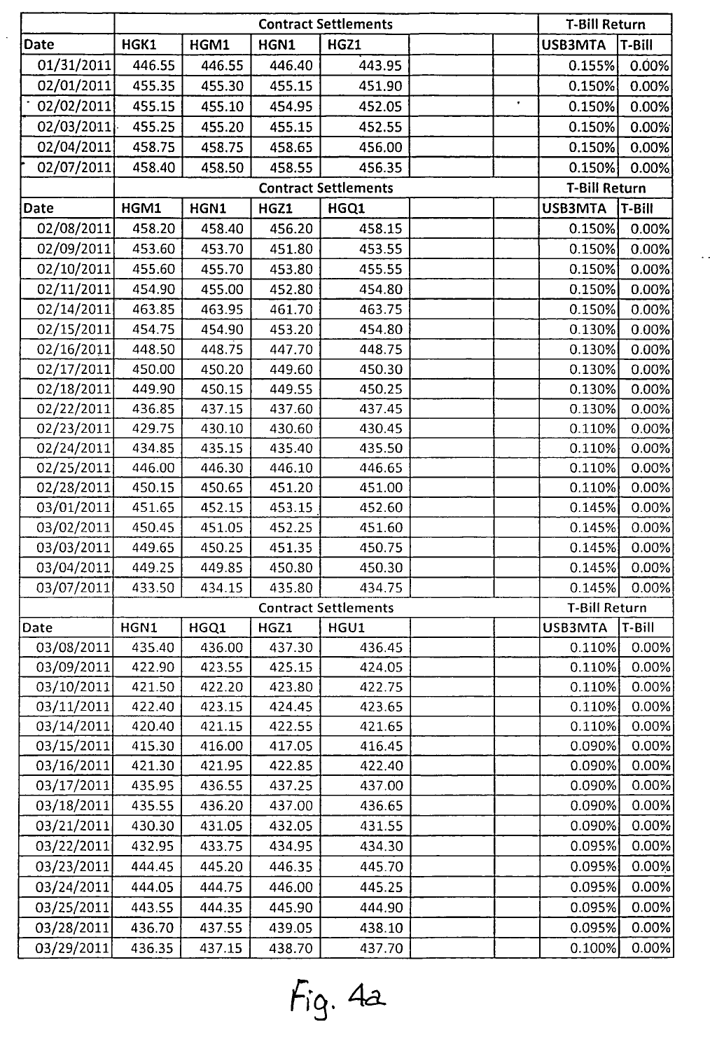

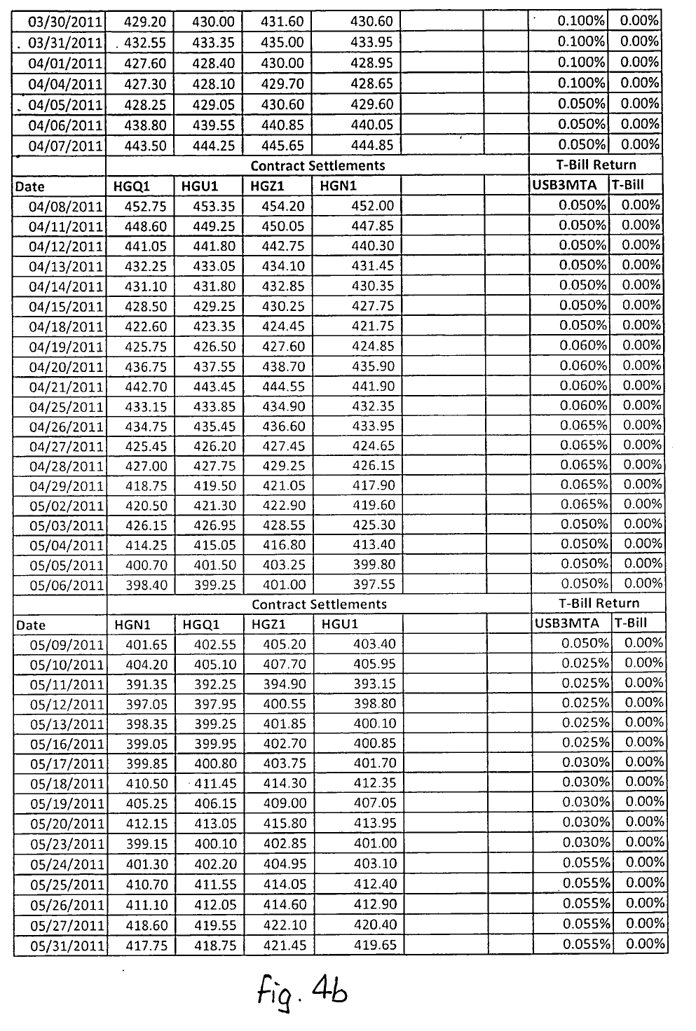

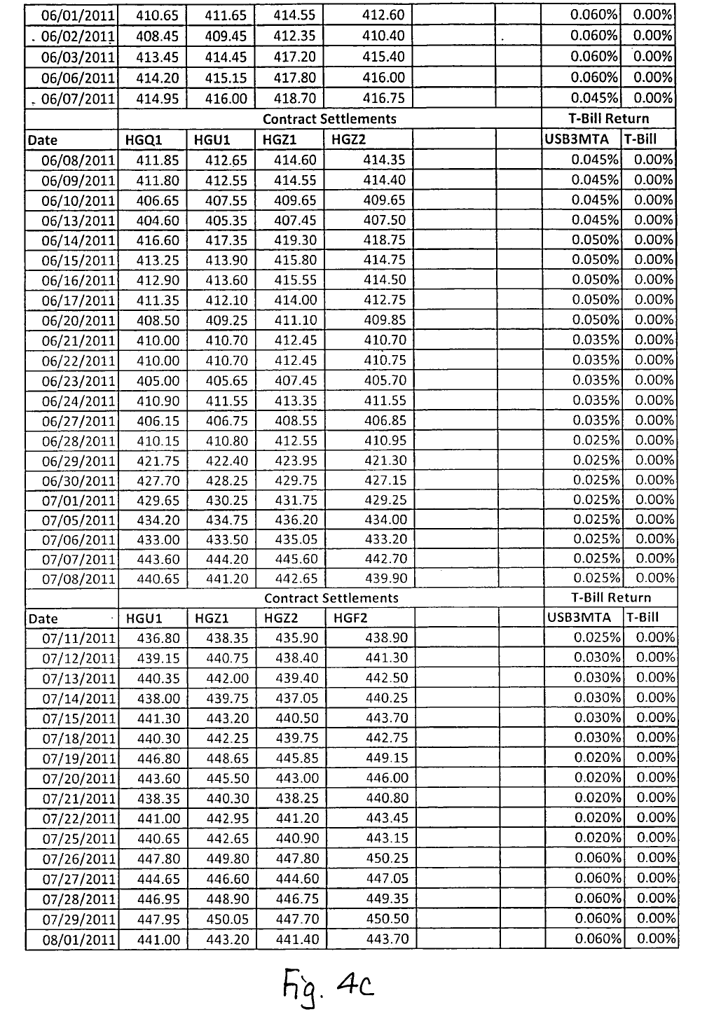

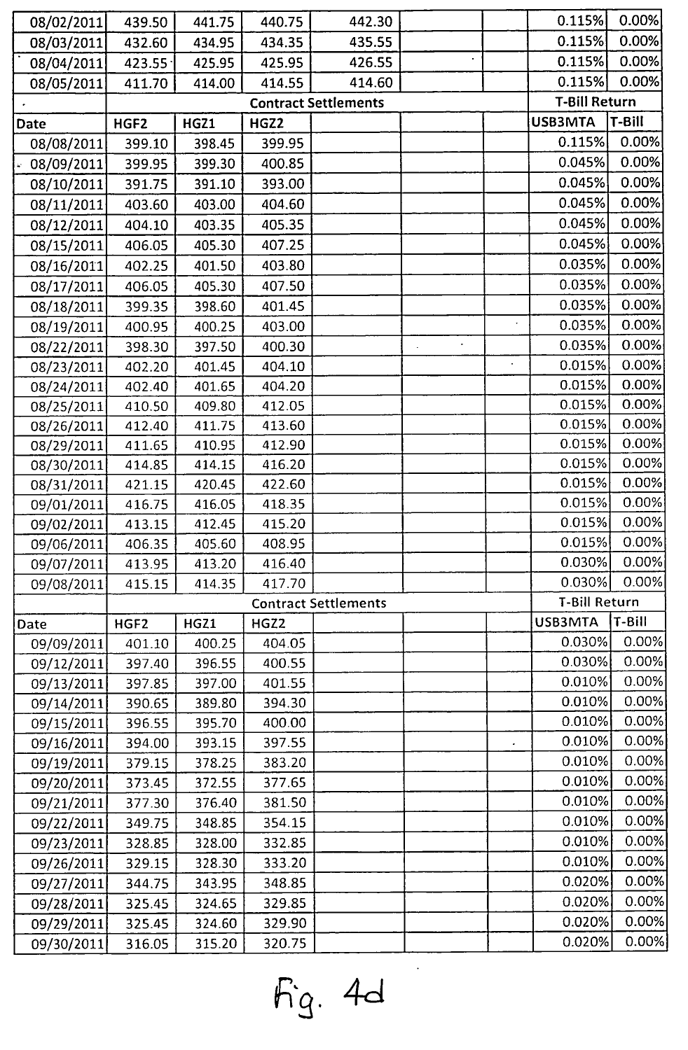

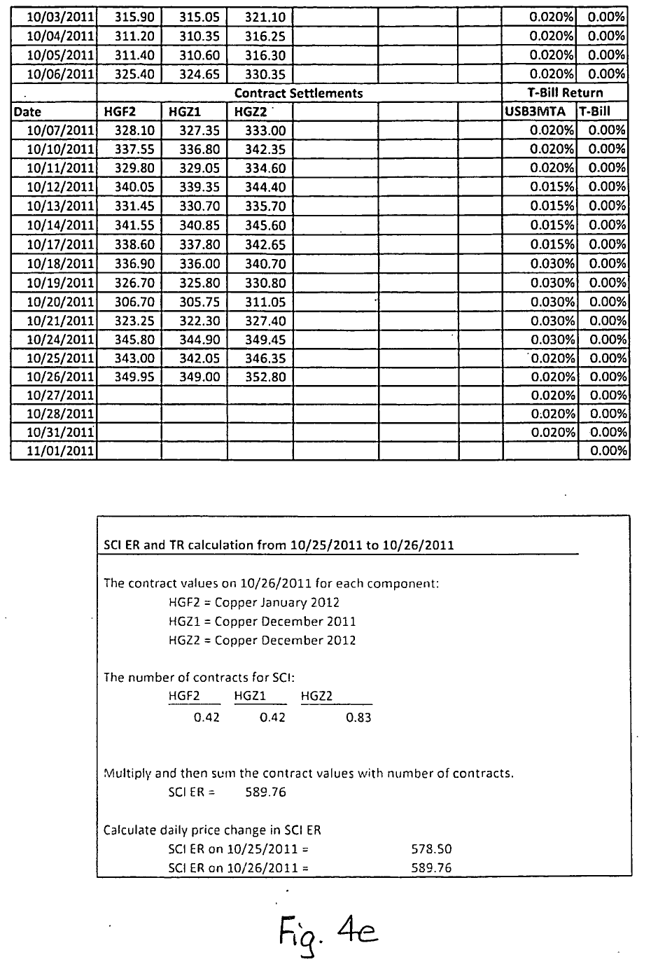

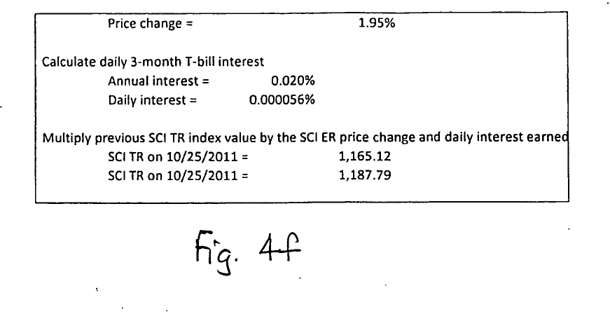

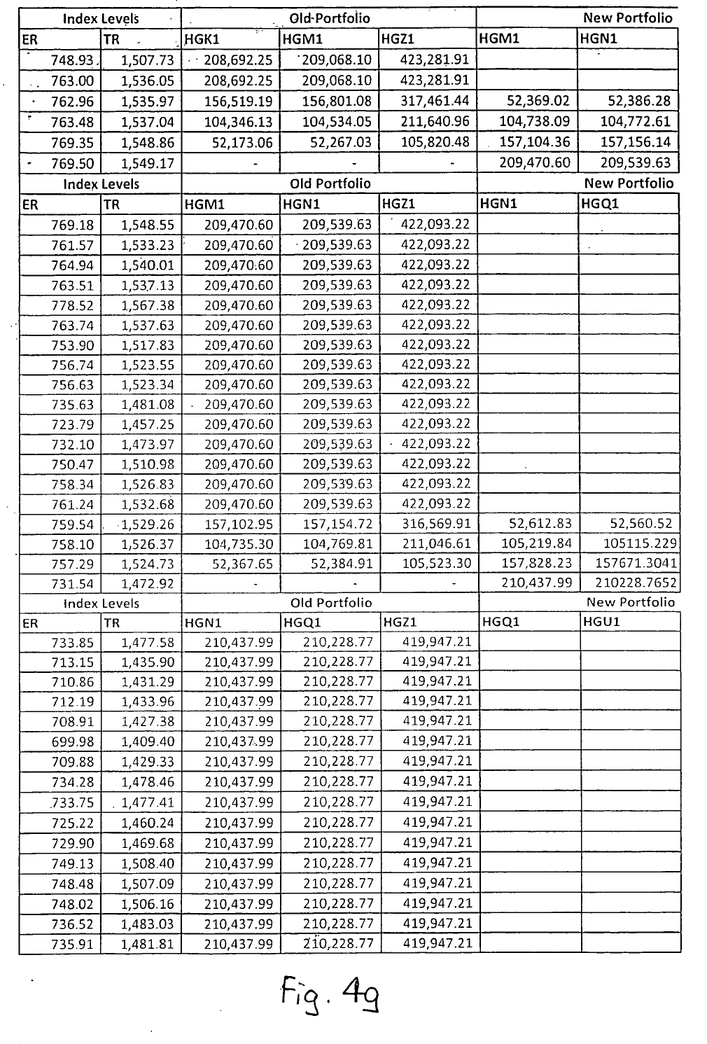

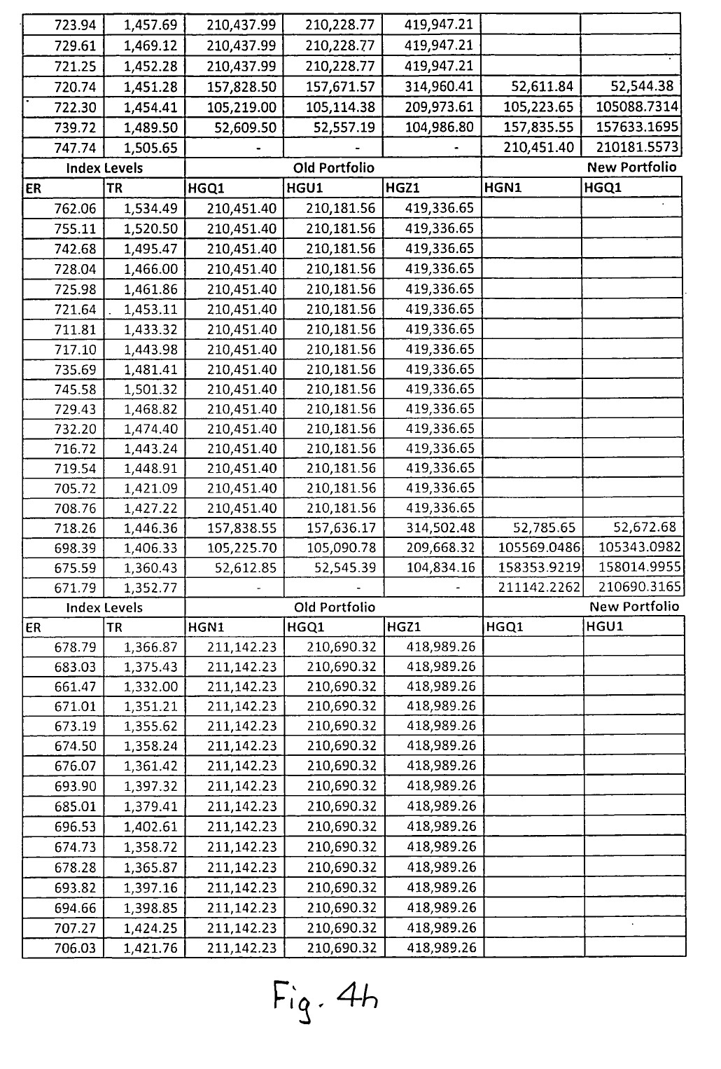

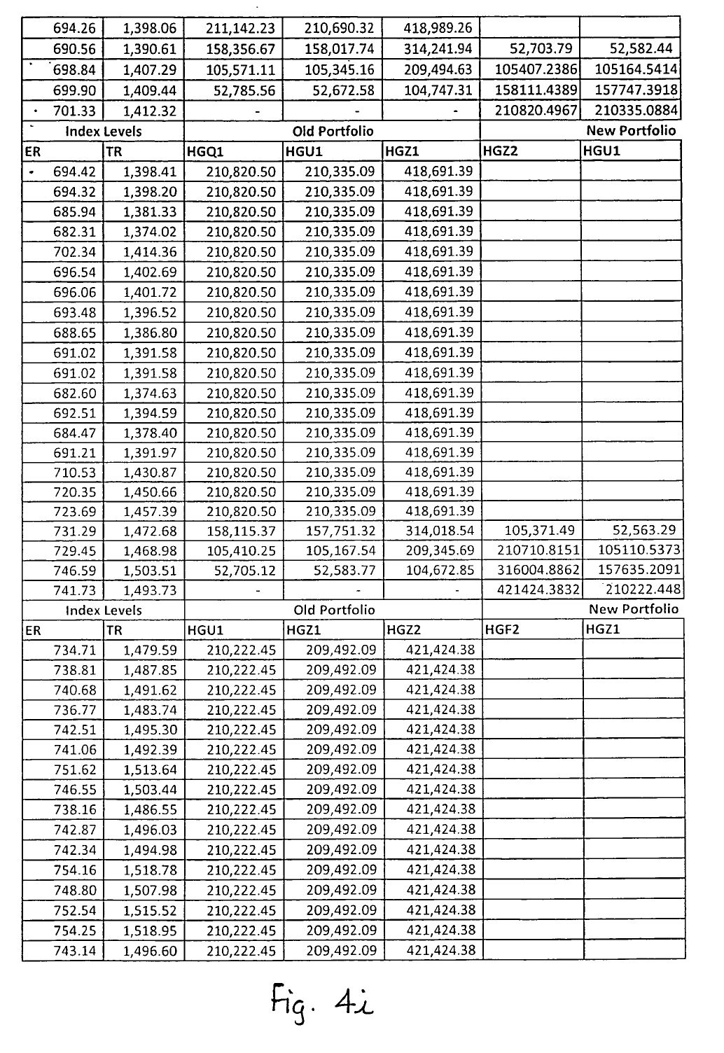

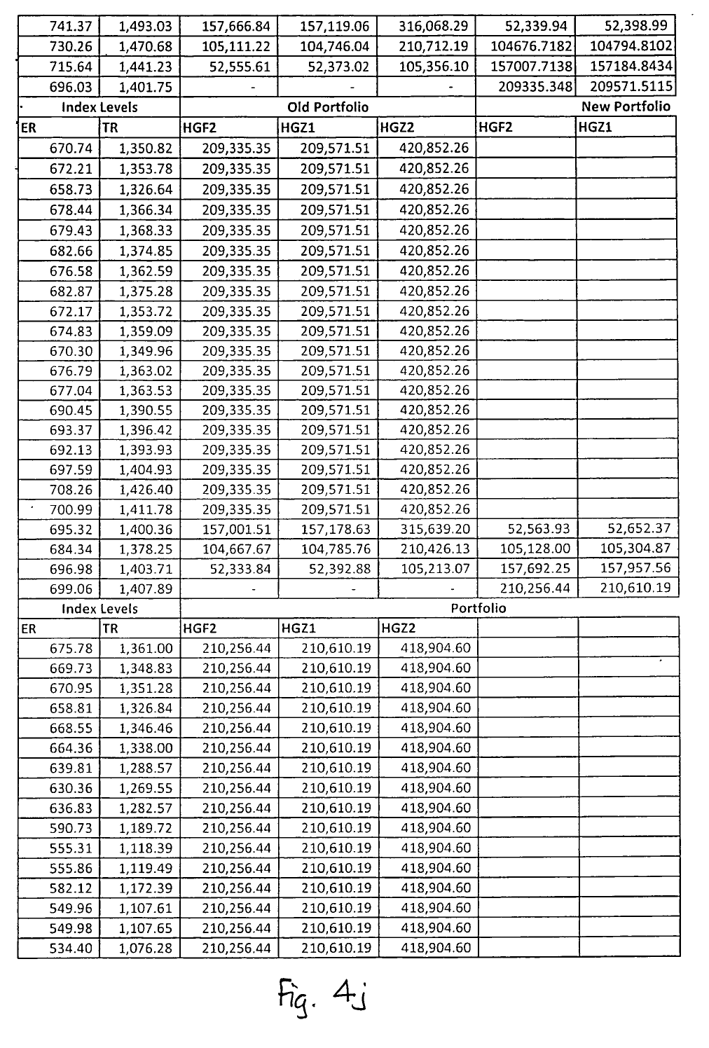

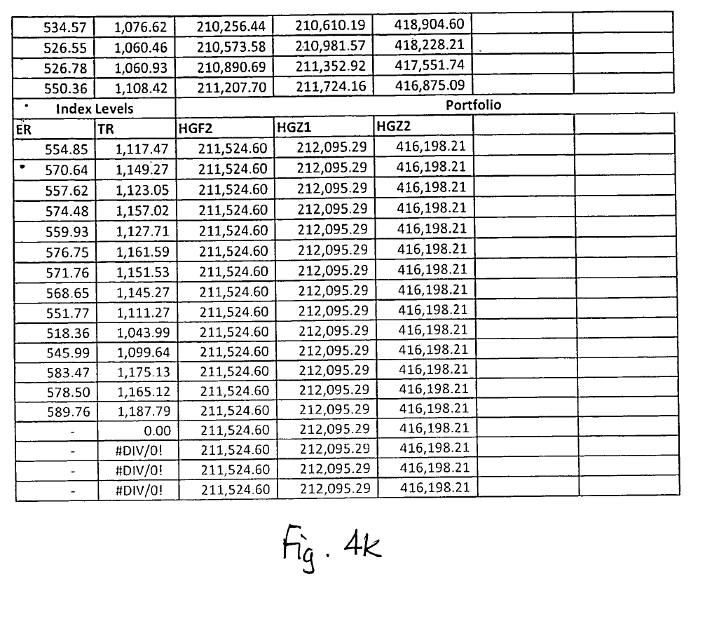

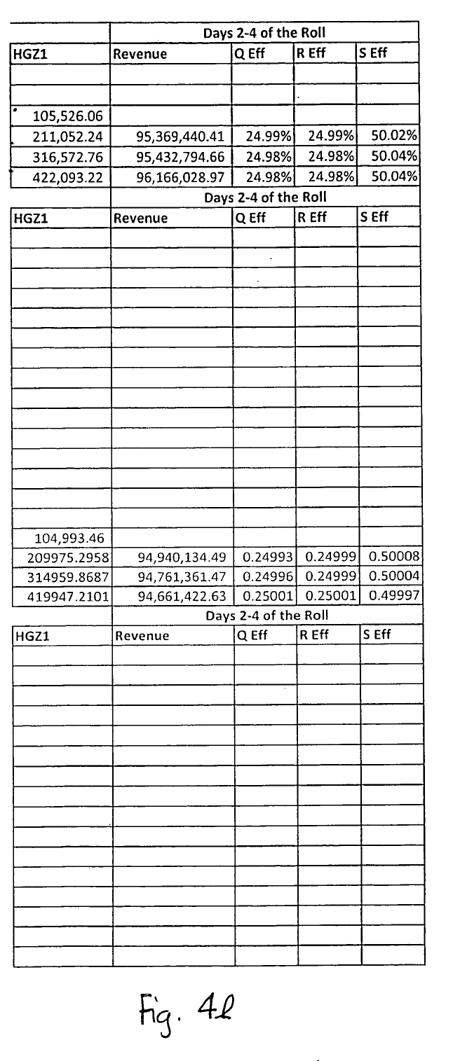

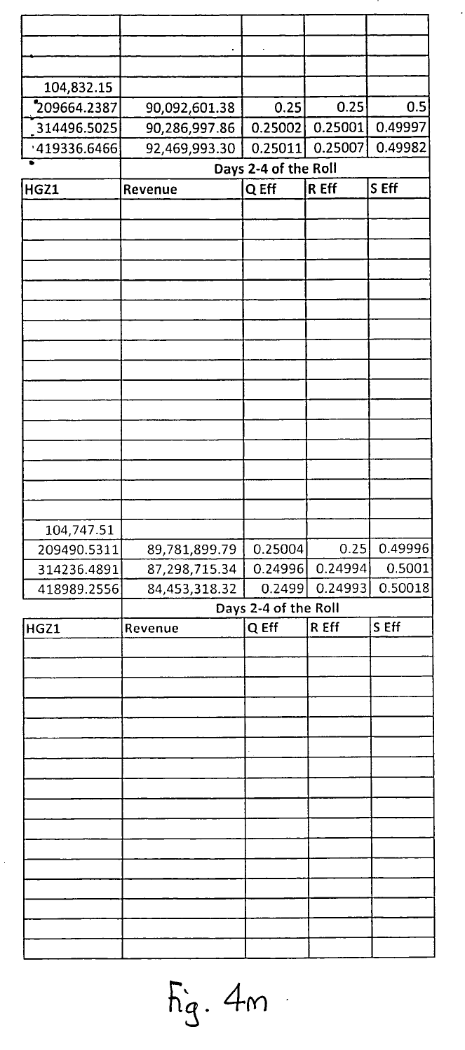

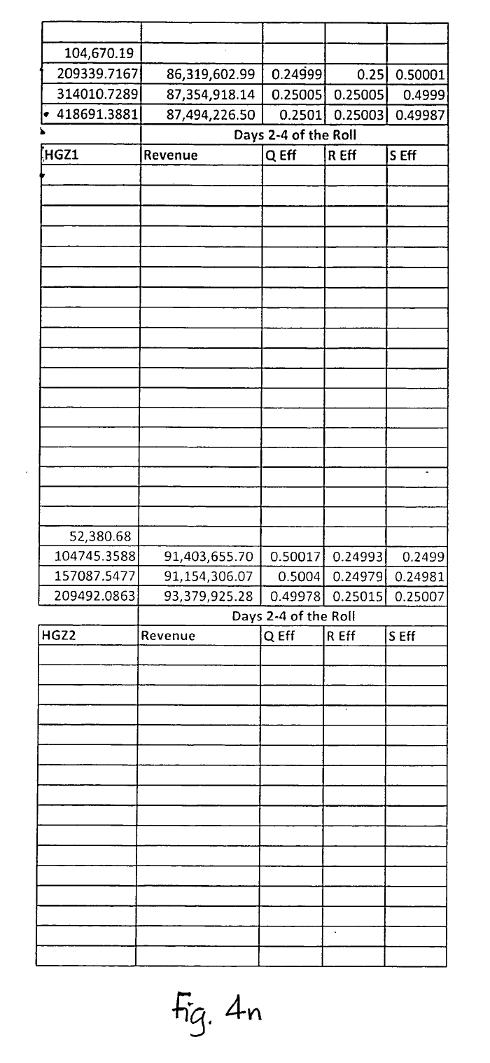

We claim:

1. A method using a computer, of providing a copper index for investors which comprises the steps of:
(a) determining the Eligible Copper Futures Contracts, based on an evaluation of Backwardation or Contango,
(b) determining the value of SCI Excess Return, and
(c) determining the value of SCI Total Return as the product of SCI TR on the immediately preceding business day multiplied by one plus the sum of the day's SCI ER returns and one business day's interest from the hypothetical U.S. Treasury Bill portfolio.
